(19) United States
(12) Patent Application Publication
(10) Pub. No.: US 2019/0156447 A1
(43) Pub. Date: May 23, 2019

(54) Flight Logging and Resource Management System

(71) Applicant: Lorenzo Curci, Bethesda, MD (US)

(72) Inventor: Lorenzo Curci, Bethesda, MD (US)

(21) Appl. No.: 15/819,074

(22) Filed: Nov. 21, 2017

(51) Int. Cl. G06Q 50/20; G06F 8/61; G06F 17/30; G06Q 10/10; G06Q 30/04; G09B 19/16

(52) U.S. Cl. CPC G06Q 50/205; G06F 8/61; G09B 19/165; G06Q 10/1095; G06Q 30/04; G06F 17/30876

(57) ABSTRACT

A system and method for logging flight durations and noting potential issues with aircraft is shown. The system includes the use of a mobile device application, which is configured for use by pilots, certified flight instructors, aircraft owners, and administrators. Within the mobile device application, users may reserve the use of an available aircraft by selecting a time slot for reservation, and flight students may select a flight instructor as well. Expenses such as fuel may be logged for reimbursement, and issues with the aircraft may easily be noted by users via an interface of the mobile device application. Users are automatically billed according to usage time of the aircraft, which may be paid within the application. Users are provided the option to note problems with the aircraft, indicating a need for maintenance or repair. Aircraft unfit for flight are removed from availability.

### FIELD OF THE PRESENT INVENTION

The present invention relates to a system for logging flight duration and other flight related data, and more specifically relates to a system for tracking the state and use of one or more aircrafts, noting issues with the aircraft, and managing a schedule of use of the aircraft via a mobile device application.

### BACKGROUND OF THE PRESENT INVENTION

Routinely, students under instruction for an aviation pilot's license are required by law to practice flying. A certain amount of verified and logged flight hours are needed before a license can be earned by an individual. Much of this flight time is guided, and requires the presence and assistance of a certified flight instructor to observe and guide the student during numerous flights.

Often, the aircraft employed for such training and practice sessions is owned by the flight instruction company or independent flight instructor. It is common that a plane may be used by several flight instructors and students each week. Much with all aviation craft, consistent and pertinent maintenance to aircrafts is required in order to ensure the safety of the aircraft, pilot, and its passengers. When an aircraft is used by several people, keeping track of what maintenance is needed and when can become confusing, as private digital logs and paper maintenance logs are primarily used. If there were a way to clarify this to users, as well as to prevent any accidental use of an aircraft in need of maintenance, aircraft rental processes could be streamlined. Additionally, if there were an easy way for users to be billed automatically based on flight hours, the billing process of aircraft use could be streamlined.

Thus, there is a need for a system by which a user may easily log his or her flight digitally, including flight duration via Hobbs hour meter and tachometer readings before and after the flight, chronicle any and all potential maintenance issues with the resource, and be automatically billed for time used plus expenses. Such a system preferably employs a mobile device application running on the mobile device of the user, and enables the user to connect to, and interact with, resource administrators and/or resource owners effectively and expediently. Information pertaining to each resource, as well as each Certified Flight Instructor is preferably stored on a relational database that is accessible via the mobile device application. Billing is preferably automated via the mobile device application, and facilitates the withdrawal of funds from users according to pre-established rates. As such, the mobile device application is preferably equipped to handle personal transactions via the internet.

### SUMMARY OF THE PRESENT INVENTION

The present invention is a flight logging and resource management system for use by users, administrators, and certified flight instructors via mobile devices. The system employs a mobile device application configured to run on conventional smartphones, tablets, and other internet connected personal devices. Users of the present invention are ideally flight students, certified flight instructors, and individual pilots wishing to rent an aircraft. Owners of the aircraft(s) and/or administrators of the aircraft(s), referenced as resources, are provided special access to the system of the present invention, and are able to delineate available times for scheduling the use of the resources by users. Resources may also be easily removed from the list of available resources when they are in need of maintenance or repair. A color-coded system is preferably employed, which enables users to quickly determine which resources are flight-ready and available for reservation, and which resources are down for maintenance.

Additionally, from within the mobile device application, users may flag a given resource as needing maintenance or needing specific attention/examination to a portion of the aircraft during or after the user's occupation of the resource.

The system of the present invention preferably provides six primary features to users and administrators, including: squawks, a hours usage log, certified flight instructor notation, expenses tracking, a resource schedule for reservations, and a digital log book of resource use, which is preferably stored in a relational database, stored on a secured server.

### BRIEF DESCRIPTION OF THE DRAWINGS

The present invention will be better understood with reference to the appended drawing sheets, wherein:

FIG. 1 exhibits a view of the mobile device application of the present invention, showing the main menu interface.

FIG. 2A displays a wire frame flow chart depicting the process of use of the present invention from the viewpoint of a student user.

FIG. 2B displays a continuation of the wire frame flow chart of FIG. 2A, depicting the process of use of the present invention from the viewpoint of a student user.

FIG. 3A depicts a wire frame flow chart showing the process of use of the present invention from the viewpoint of an administrator.

FIG. 3B displays a continuation of the wire frame flow chart of FIG. 3A, showing the process of use of the present invention from the viewpoint of an administrator.

FIG. 4A shows a wire frame flow chart depicting the process of use of the present invention from the viewpoint of a Certified Flight Instructor (CFI).

FIG. 4B shows a continuation of the wire frame flow chart of FIG. 4A, detailing the process of use of the present invention from the viewpoint of a Certified Flight Instructor.

FIG. 5 depicts a standard flow chart explaining the real-world process of use of the present invention.

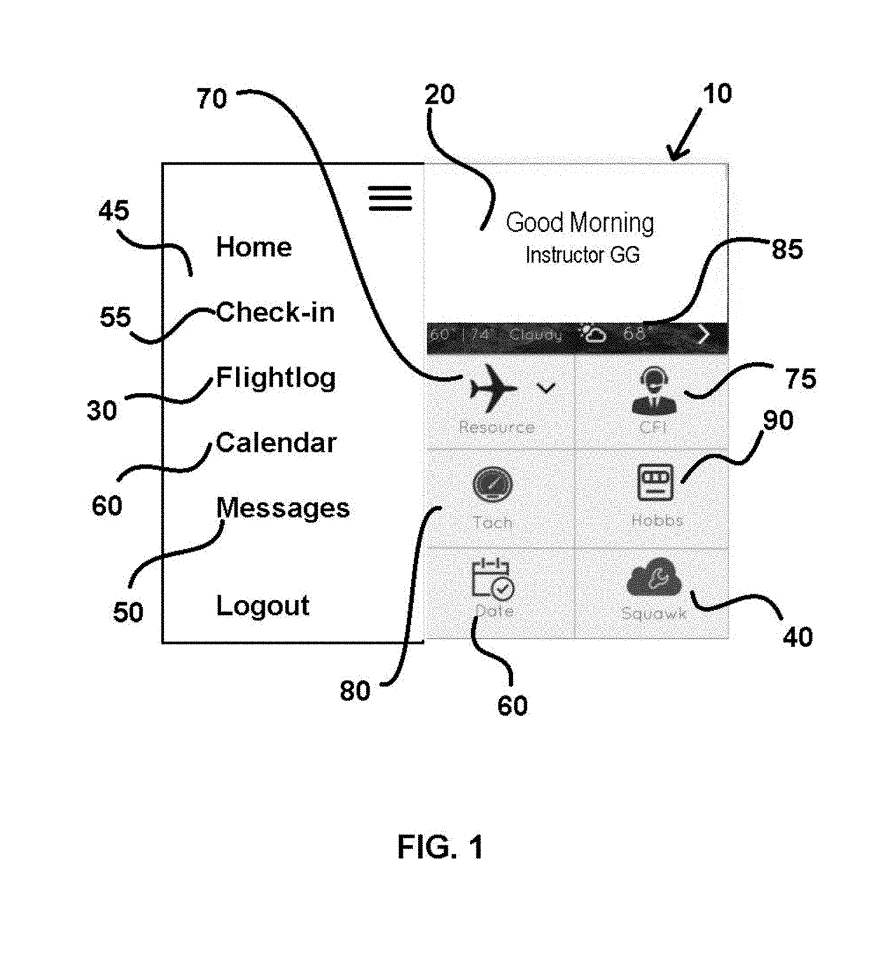

### DETAILED DESCRIPTION OF THE PREFERRED EMBODIMENT

The present invention is a system by which users, owners, and administrators of aircraft may easily and conveniently log, check, and schedule aircraft-related activities. The system of the present invention employs a mobile device application (10), which is preferably configured for use on conventional smart phones, tablets, and other mobile devices. The mobile device application (10) is preferably configured to connect to a network and/or the internet via internal wireless radios of the mobile device, such as WiFi and/or Bluetooth TM. The features and services provided via the mobile device application (10) vary in accordance with the authority of the user.

For example, an administrator is afforded features such as a Manage Reservations and Lessons menu (220) which is accessible via a scheduler menu (200), a user management menu (210), a permissions interface (230), and a resource management menu (240). From the resource management menu (240), an administrator may check on current resource inventory via an inventory menu (260), set a status (270) of a given resource (such as grounding a resource, lock out use of a given resource by user(s) via a permissions menu (280), and view/change the status of squawks (40). Similarly, a Flight Student user is afforded features pertaining to scheduling and executing a flight lesson, as well as paying for the lesson. After successfully scheduling a flight or flight lesson, the user may navigate to a check-in menu (290) which allows the user to input pre-flight Hobbs and/or Tachometer meter readings to be saved to a secured server database of the present invention. The system of the present invention also notes the geographical location of the user both pre-flight and post-flight, and saves the data to the secured server database.

The mobile device application (10) of the present invention is preferably equipped with an interface (20), which is accessible to the user via the touchscreen of the mobile device. The interface (20) provides the user with easy access to available resources, and provides the user with an assortment of data pertaining to each resource, as well as a listing of documented certified flight instructors.

The interface (20) of the application (10) of the present invention is equipped with a variety of features that are accessible to the user. Some of these features include a flightlog (30), a squawk (40) feature for reporting issues with a resource, messages (50) to facilitate communication, and a calendar (60) used for scheduling use of a resource. The flightlog (30) facilitates a user logging flight information, including, but not limited to departure times, arrival times, resource used, accompanying CFI name, the route of the flight, the duration of the flight, any anomalous encounters or events experienced during the flight, as well as other notes. It is envisioned that in some embodiments of the present invention, the flightlog (30) may auto-populate some data, such as those input within the tach (80) and Hobbs meter (90) icons.

Additionally, the interface (20) is equipped with a CFI menu (75), a resource menu (70), weather conditions listing (80) which is location-sensitive, a tach icon (80) and a Hobbs icon (90). A check-in feature (55) facilitates a user checking-in to use, reserve, or determine the status of a given resource quickly and easily from a main menu (45) of the interface. The calendar (60) is available from the interface (20) for scheduling use of a resource, as well as the time of a CFI.

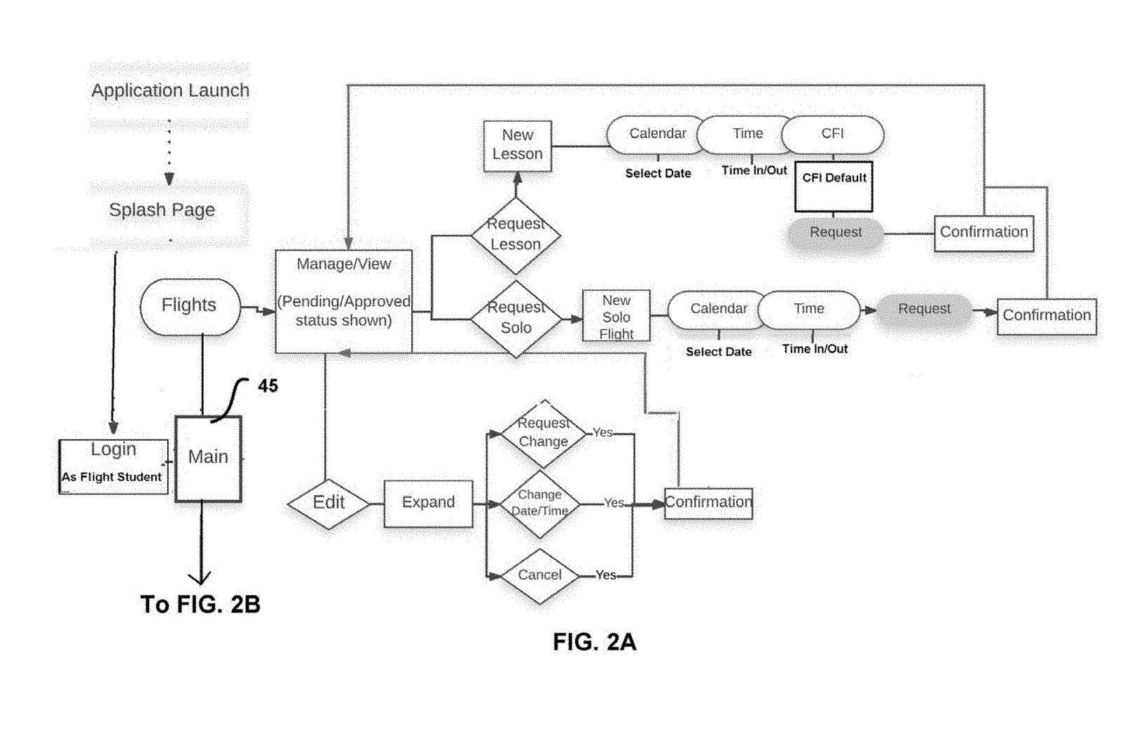

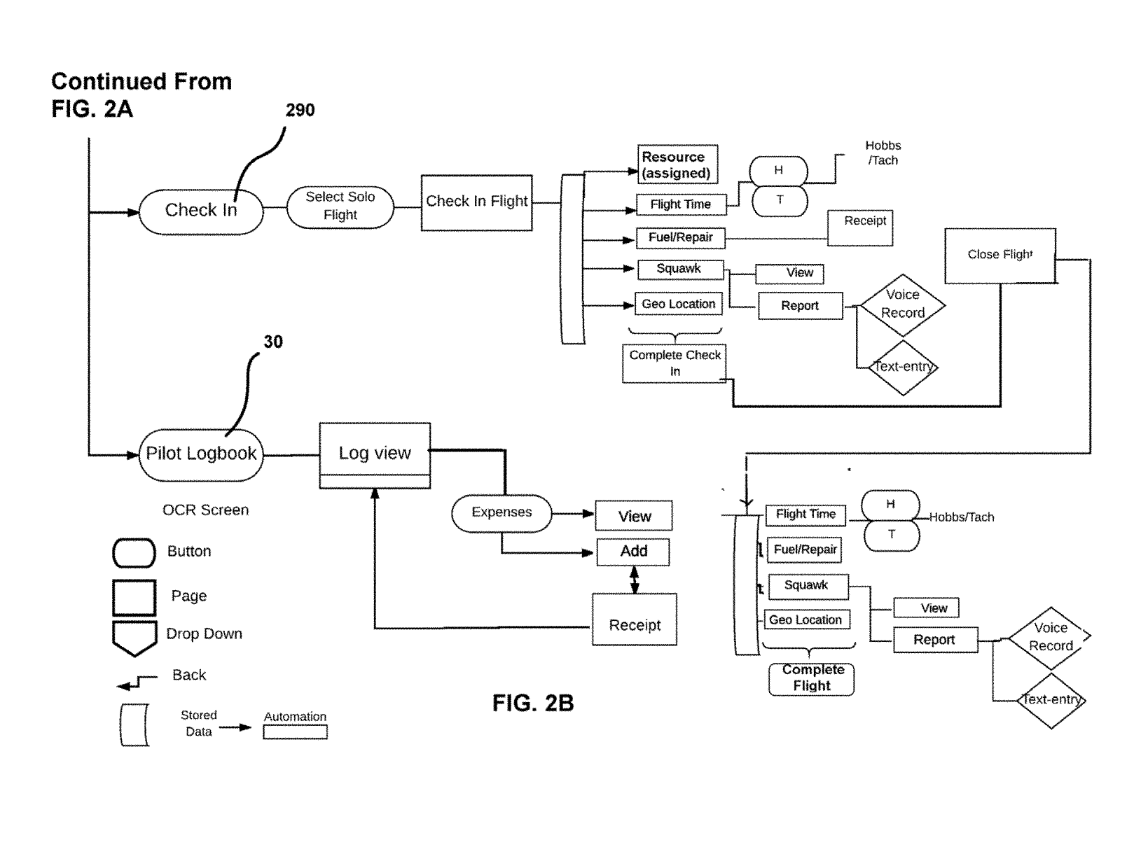

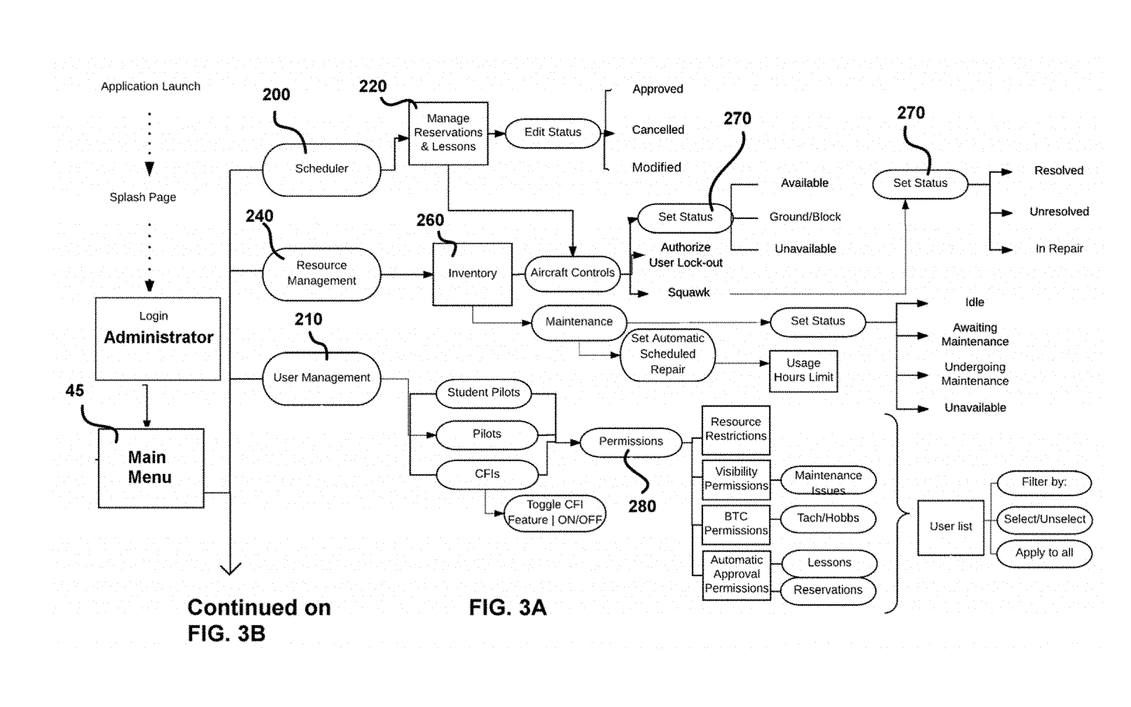

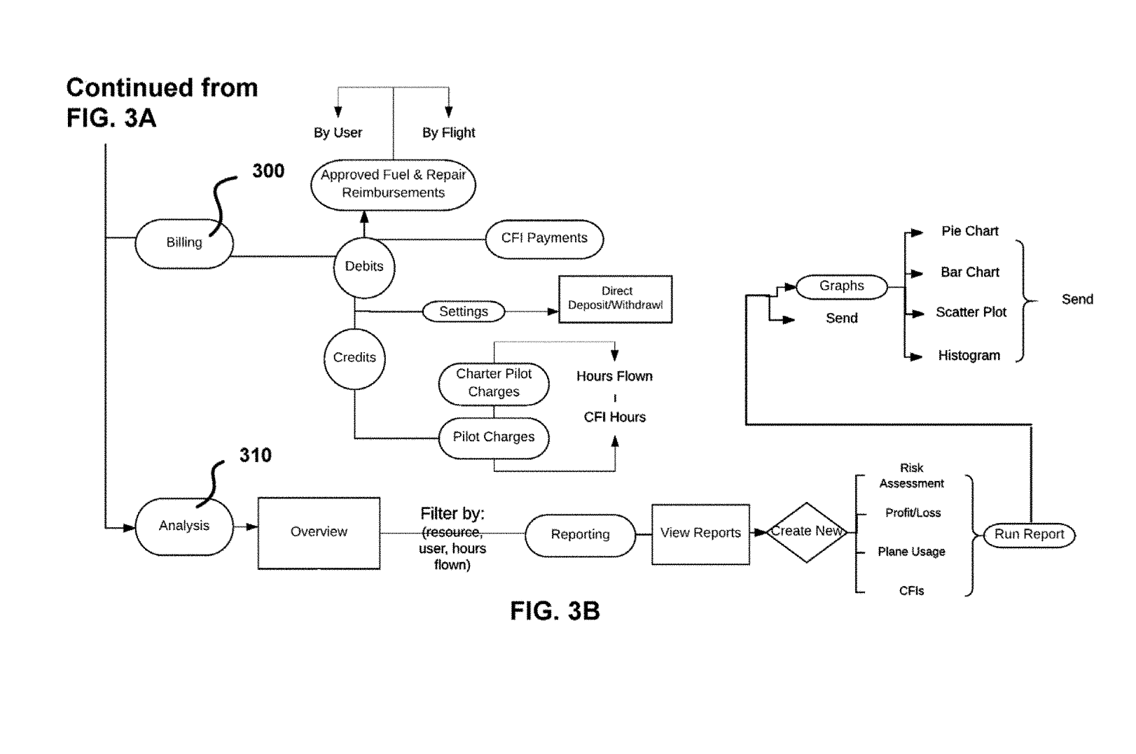

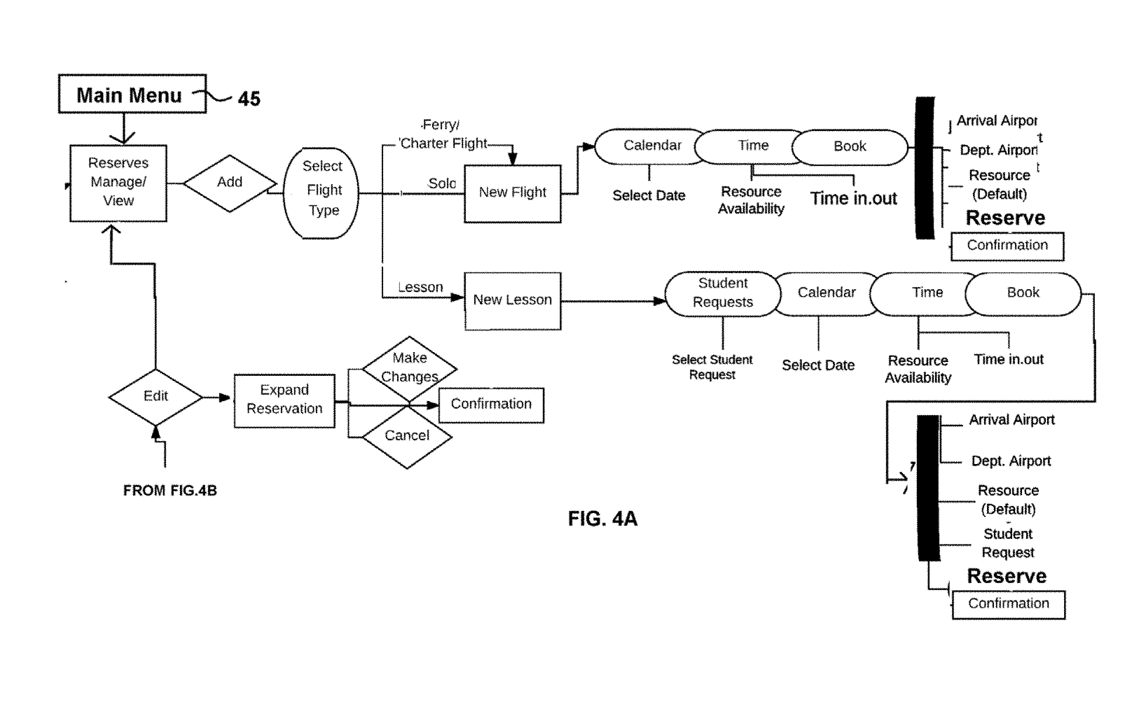

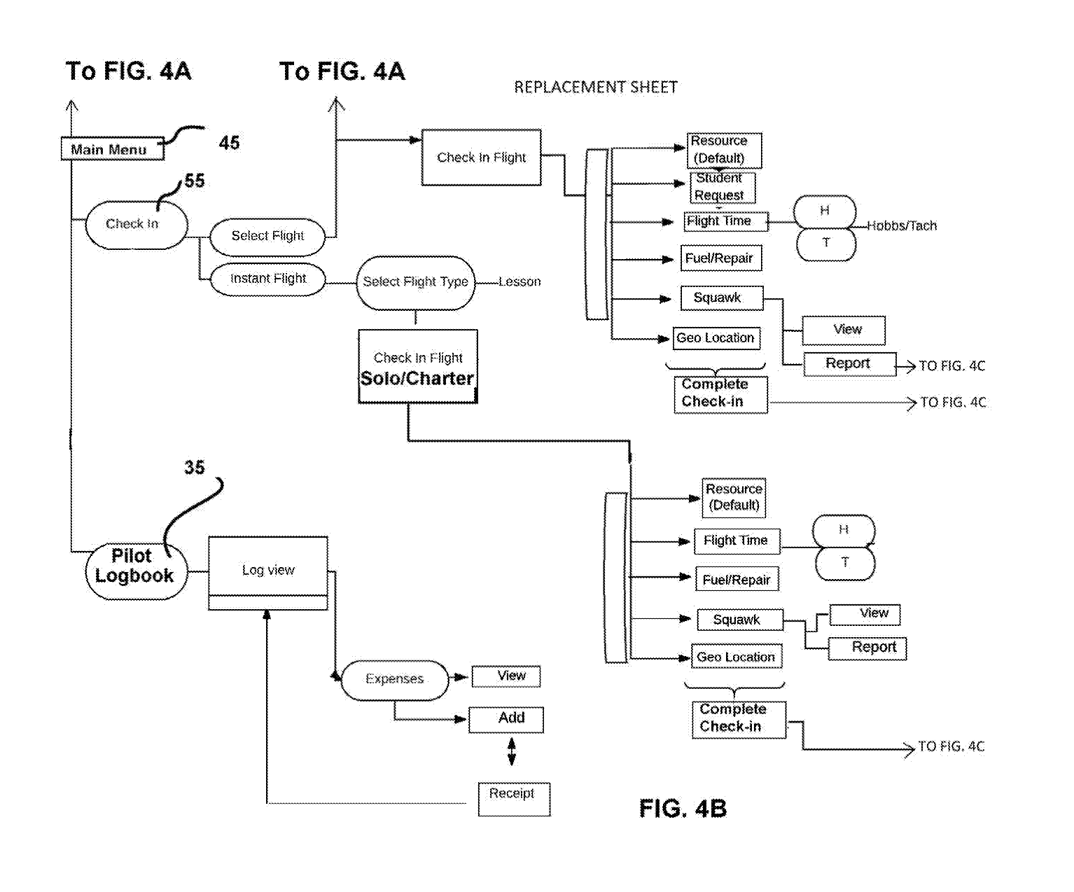

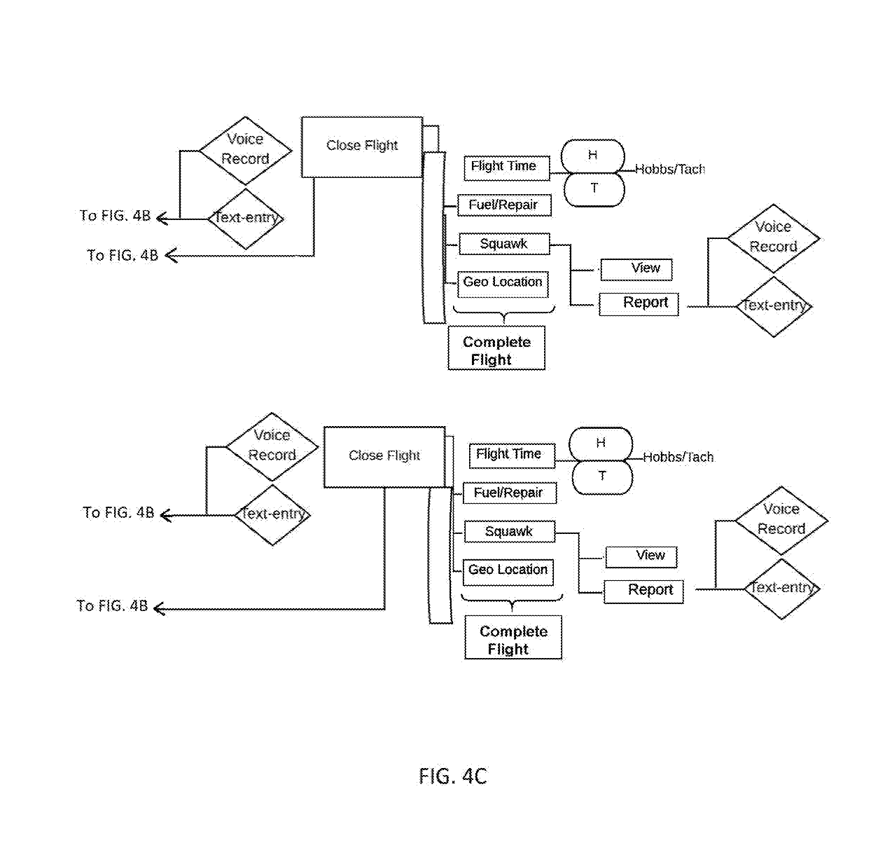

As shown in FIG. 2, the overall layout of use of the system of the present invention for reservation of a resource by a flight student is preferably as follows:

1. First, the user launches the mobile device application (10) of the present invention and is shown a splash screen depicting a logo/splash screen of the present invention while the application is loaded into active memory on the mobile device.

2. Next, the user logs into the system using his or her authenticated credentials. A username and password are preferably employed, however biometric authentication may also be supported if the mobile device is equipped with a fingerprint scanner. A user may log in as an Administrator, Flight Student, CFI, or Pilot.

3. The user is then presented with the main menu (45), which allows the user to navigate to a variety of features. The user may opt to schedule a flight, or view his or her pilot flightlog (30).

4A. If the user opts to view the flightlog (30), the user is presented with a log of previous flights. The user may opt to view his or her expenses incurred from prior flights, to add an expense incurred, and/or obtain a receipt for the expense(s). Preferably, billing for expenses may also be directed from this menu.

4B. If the user opts to schedule a flight, the user is taken to the flight screen (95), which enables the user to request and schedule a flight lesson.

5. Upon opting to schedule a flight lesson, the user is taken to the calendar (60) for scheduling the lesson. The user is prompted to select an available date for the lesson, as well as an available time at which the lesson will take place. Only available timeslots are preferably displayed to the user. Unavailable timeslots are greyed-out, and are unavailable for selection.

6. Prior to submitting the request for a lesson, the user is prompted to select an available CFI. The user selects a CFI, and then taps a ‘request’ button.

7. The user is supplied with confirmation that the request was accepted.

8. In the event that the user must reschedule, or otherwise make a change to his or her requested lesson, the interface (20) of the mobile device application (10) facilitates changes via a ‘manage/view’ screen. From the manage/view screen, the user may request a change of date, a change of time, or cancel the requested lesson. Confirmation is supplied to the user after a change has been made to the scheduled lesson.

While in-flight or after flight, users may document potential issues with the resource via the squawk (40) tab. Upon clicking squawk (40), a separate ‘Squawk Tab’ is shown to facilitate a user reporting an issue. In some embodiments of the present invention, the mobile device application (10) may automatically flag resources which have been used for X amount of time, the time duration being the maximum allowed before scheduled maintenance is performed. Such resources that are down for maintenance are not shown as available resources within the resource (70) menu. Only the administrator is able to verify when maintenance has been performed, and the resource is ready for use again. Users are provided the opportunity to document any resource issues during or post-flight via the squawk (40) tab. In some embodiments of the present invention, this option is only available post-flight.

It should be understood that the mobile device application (10) of the present invention is configured to automate airplane or other aircraft usage for billing purposes via a mobile device, providing an integrated flightlog solution.

The system of the present invention is preferably equipped with six primary functions, described as follows:
1. Squawks: Squawks are a feature of the mobile device application of the present invention, which allow users to note issues with the resource (airplane) that may affect flight worthiness. Squawks are sent to the administrator automatically, and can be made available to other users at the will of the administrator.
2. Usage Log. The user is prompted by the mobile device application to record either or both the Hobbs hour meter reading and the tachometer reading in order to establish a Billing Time Charge or “BTC,” which is automatically forwarded to the administrator via the mobile device application for billing purposes.
3. Certified Flight Instructor (CFI) Notation. The user may identify the CFI from a drop down menu within the interface (20) of the mobile device application (10). The mobile device application (10) will then forward the BTC to the administrator and CFI automatically after completion.
4. Expenses. Fuel, repair and maintenances charges incurred by the User will be forwarded to the Administrator.
5. Resource Schedule. The Resource availability for the User will be available through a schedule maintained by the Administrator.
6. Log Book. Resource use will be forwarded to the User's logbook.

An administrator is also afforded an Analysis Menu (310), which facilitates reporting on resource use, users, hours flown, and profits. Additionally, the Analysis menu (310) allows the administrator to create graphs such as pie charts, bar charts, scatter plot diagrams, and histograms of the data.

### Squawks:

The mobile device application (10) of the present invention is configured to maintain an electronic diary of maintenance issues relating to the resource. A user may issue a ‘squawk’ via the mobile device application (10) from a squawk tab (40) that relates to a specific issue with the resource, which is then conveyed to the administrator. The administrator, via his or her mobile device, determines the availability of this information to users via the mobile device application (10) of the present invention. The administrator can authorize a user to lock-out availability of the resource, ensuring that no user may schedule time for use of the resource until any and all maintenance issues have been addressed. Resources are preferably color-coded within the mobile device application (10), and will reflect, in real-time, whether maintenance issues have been resolved. It is envisioned that the color coding of a resource that is ready-for-use is ‘green.’ Conversely, red, yellow, or black color coding is preferably used when a resource is unavailable for use, and is undergoing maintenance, major repair, or nearing completion.

### Usage Log:

Through the use of Optical Character Recognition (OCR), a user of the system of the present invention may record the beginning time and values of either or both of the resource's tachometer and Hobbs hour meter via the mobile device application (10) of the present invention. Upon completing use of the resource (aircraft), the user is prompted to record the end time values of either or both tachometer and Hobbs hour meter, and create the Billing Time Charge (BTC) via the mobile device application (10). It should be understood that the BTC is the incurred cost.

Usage time information from the Hobbs hour meter and/or the tachometer may be collected via manual input from the user, however the data is preferably captured via an internal camera of the mobile device running the mobile device application (10) of the present invention. The image captured is then read by the mobile device application (10), and is converted into numeric text for input into the relational database in communication with the mobile device application (10). This information is forwarded to the administrator for purposes of billing using the Applications Billing Program (ABP). The ABP will create a bill and related information for the User, which the user must pay after use of the resource. The ABP is preferably configured to automatically charge the credit card of the user via the mobile device application (10). The ABP is also shown as ‘billing’ via billing menu (300).

### Certified Flight Instructor (CFI) Time and Billing:

The user is prompted to identify the certified flight instructor from the drop down menu shown in the interface (20) of the mobile device application (10), as shown in FIG. 2. The Billing Time Charge (BTC) will be forwarded to the administrator and the certified flight instructor. The Administrator will automatically charge the user's credit card, debit card, or prepaid account.

### Expenses:

After each use of a resource, the user is preferably prompted via the mobile device application (10) to record any and all fuel and repair charges that were spent by the user, and to take a picture of the receipt which will be forwarded to the Administrator for reimbursement request (Approved Fuel and Repair Reimbursements or “AF&RR”). These values are preferably entered into fields shown on the interface (20), or are provided via a drop-down menu selection.

### Resource Schedule:

The administrator of each resource provides the resource's availability via the mobile device application (10) of the present invention, and may update the availability of the resource(s) easily from via the interface (20). Additionally, users can self-schedule use of the resource, such that the user is automatically scheduled for use of a selected resource according to a consistent timeslot as long as the resource is available and not currently undergoing maintenance.

### Log Book:

The User's BTC information is automatically forwarded wirelessly to an electronic logbook, preferably stored in a relational database on a server in communication with the mobile device application (10) of the present invention. The logbook may be accessed via a pilot logbook menu (35) of the present invention.

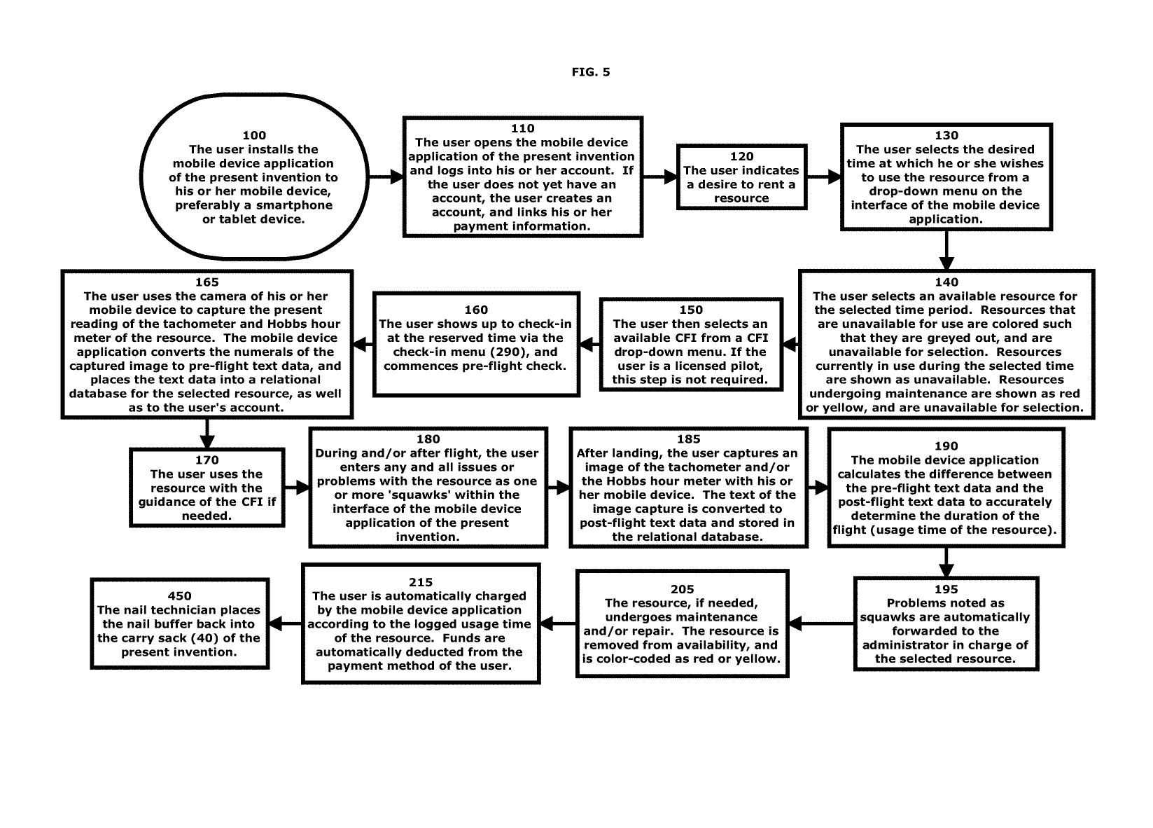

The short-form of the process of installation and use of the present invention, as depicted in FIG. 5, is preferably as follows:
1. The user (flight student, pilot, or administrator) installs the mobile device application of the present invention to his or her mobile device, preferably a smartphone or tablet device. (100)
2. The user opens the mobile device application of the present invention and logs into his or her account. If the user does not yet have an account, the user creates an account, and links his or her payment information. (110)
3. The user indicates a desire to rent a resource. (120)
4. The user selects the desired time at which he or she wishes to use the resource from a drop-down menu on the interface of the mobile device application. (130)
5. The user selects an available resource for the selected time period. Resources that are unavailable for use are colored such that they are greyed out, and are unavailable for selection. Resources currently in use during the selected time are shown as unavailable. Resources undergoing maintenance are shown as red or yellow, and are unavailable for selection. (140)
6. The user then selects an available CFI from a CFI drop-down menu. If the user is a licensed pilot, this step is not required. (150)
7. The user shows up to check-in at the reserved time via the check-in menu (290), and commences pre-flight check. (160)
8. The user uses the camera of his or her mobile device to capture the present reading of the tachometer and Hobbs hour meter of the resource. The mobile device application converts the numerals of the captured image to pre-flight text data, and places the text data into a relational database for the selected resource, as well as to the user's account. (165) The information is preferably stored on a secured server accessible via the mobile device application of the present invention.
9. The user uses the resource with the guidance of the CFI if needed. (170)
10. During and/or after flight, the user enters any and all issues or problems with the resource as one or more ‘squawks’ within the interface of the mobile device application of the present invention. (180)
11. After landing, the user captures an image of the tachometer and/or the Hobbs hour meter with his or her mobile device. The text of the image capture is converted to post-flight text data and stored in the relational database. (185)
12. The mobile device application calculates the difference between the pre-flight text data and the post-flight text data to accurately determine the duration of the flight (usage time of the resource). (190)
13. Problems noted as squawks are automatically forwarded to the administrator in charge of the selected resource. (195)
14. The resource, if needed, undergoes maintenance and/or repair. The resource is removed from availability, and is color-coded as red or yellow. (205)
15. The user is automatically charged by the mobile device application according to the logged usage time of the resource. Funds are automatically deducted from the payment method of the user. (215)

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A system for flight resource reservation, usage logging, and billing comprising:
a flight student installing a mobile device application to a mobile device of the flight student;
the flight student launching the mobile device application;
the flight student logging into an interface of the mobile device application;
the mobile device application connecting to a secured server database;
the mobile device application verifying the credentials of the flight student;
the flight student indicating to the mobile device application a desire to reserve use of a resource;
the flight student selecting a resource for use via a flights menu as a selected resource;
the flight student selecting a time and date at which the flight student desires to reserve use of the selected resource, provided via the secured server database, from a calendar interface of the mobile device application;
the mobile device application providing the option of requesting a flight lesson to the flight student;
the mobile device application providing the option of requesting a solo flight to the flight student;
the flight student selecting a Certified Flight Instructor from a list of available Certified Flight Instructors from the secured server database for the time selected by the flight student upon selection of the option to request a flight lesson; and
the flight student confirming the selected time, date, and Certified Flight Instructor via a confirmation interface of the mobile device application.

2. The system of claim 1, further comprising:
the flight student arriving at the selected resource at the time selected;
the flight student logging in to the mobile device application on the mobile device of the flight student;
the flight student navigating to a check-in menu;
the flight student checking in for a flight using the selected resource;
the flight student navigating to a Hobbs/Tach menu from the check-in menu;
the mobile device application launching an on-board camera of the mobile device of the flight student;
the flight student capturing a first picture of the Hobbs meter and tachometer on-board the resource with the camera of the mobile device;
the mobile device application employing image recognition for the numerals shown within the first picture;
the mobile device application producing a first converted text reading of the Hobbs meter and tachometer;
the mobile device application saving the first converted text reading as a pre-flight reading;
the mobile device application recording the geographic location of the flight student and selected resource prior to flight;
the flight student conducts the flight with the Certified Flight Instructor;
the mobile device application providing the flight student the option to record issues with the selected resource during use of the selected resource via voice input;
the flight student landing the selected resource;
the flight student navigating to the Hobbs/Tach menu;
the mobile device application launching the on-board camera of the mobile device;
the flight student capturing a second picture of the Hobbs meter and tachometer of the selected resource;
the mobile device application employing image recognition for the numerals shown within the second picture;
the mobile device application producing a second converted text reading of the Hobbs meter and tachometer;
the mobile device application saving the second converted text reading as a post-flight reading;
the mobile device application recording the geographic location of the flight student and selected resource after the flight;
the mobile device application comparing the pre-flight reading and post-flight reading to determine a duration of use time of the flight student;
the flight student inputting fuel costs borne by the flight student during use of the selected resource via an expenses menu of the mobile device application as a first expense;
the flight student inputting repair costs borne by the flight student during use of the selected resource via the expenses menu of the mobile device application as a second expense;
the mobile device application executing an algorithm based on the values of the first expense, the second expense, the duration of use time of the flight student, and the selected resource used to determine an incurred cost;
the mobile device application saving the incurred cost to the secured server database with the duration of use time, the current time, and the current date as attributes of the incurred cost;
the mobile device application billing the flight student the full amount of the incurred cost;
the mobile device application providing the flight student an option to pay the incurred cost via a payment menu of the mobile device application;
the flight student opting to pay the incurred cost via the payment menu; and
the mobile device application interfacing with a bank account of the flight student to pay the incurred cost.

3. The system of claim 1, further comprising:
the flight student navigating to a pilot logbook via the interface of the mobile device application;
the mobile device application providing the flight student the option to view a flight log of the flight student;
the flight log of the flight student including information pertaining to previous flights;
the mobile device application providing the flight student the option to add an entry to the flight log of the flight student;

4. The system of claim 3, further comprising:
the flight student adding an entry to the flight log of the flight student via the flight log menu of the mobile device application as a new flightlog entry; and
the mobile device application saving the new flightlog entry to the secured server database.

5. A system for flight resource reservation, usage logging, and billing comprising:
a pilot installing a mobile device application to a mobile device of the pilot;
the pilot launching the mobile device application;
the pilot logging into an interface of the mobile device application;
the mobile device application connecting to a secured server database;
the mobile device application verifying the credentials of the pilot;
the pilot indicating to the mobile device application a desire to reserve use of a resource;
the pilot selecting a resource for use via a flights menu as a selected resource;
the pilot selecting a time and date at which the pilot desires to reserve use of the selected resource, provided via the secured server database, from a calendar interface of the mobile device application;
the mobile device application providing the option of requesting an instant flight to the pilot;
the pilot confirming the selected time, and date via a confirmation interface of the mobile device application;
the pilot arriving at the selected resource at the time selected;
the pilot logging in to the mobile device application on the mobile device of the pilot;
the pilot navigating to a check-in menu;
the pilot checking in for a flight using the selected resource;
the pilot navigating to a Hobbs/Tach menu from the check-in menu;
the mobile device application launching an on-board camera of the mobile device of the pilot;
the pilot capturing a first picture of the Hobbs meter and tachometer on-board the resource with the camera of the mobile device;
the mobile device application employing image recognition for the numerals shown within the first picture;
the mobile device application producing a first converted text reading of the Hobbs meter and tachometer;
the mobile device application saving the first converted text reading as a pre-flight reading;
the mobile device application recording the geographic location of the pilot and selected resource prior to flight;
the pilot conducts the flight;
the mobile device application providing the pilot the option to record issues with the selected resource during use of the selected resource via voice input;
the pilot landing the selected resource;
the pilot navigating to the Hobbs/Tach menu;
the mobile device application launching the on-board camera of the mobile device;
the pilot capturing a second picture of the Hobbs meter and tachometer of the selected resource;
the mobile device application employing image recognition for the numerals shown within the second picture;
the mobile device application producing a second converted text reading of the Hobbs meter and tachometer;
the mobile device application saving the second converted text reading as a post-flight reading;
the mobile device application recording the geographic location of the pilot and selected resource after the flight;
the mobile device application comparing the pre-flight reading and post-flight reading to determine a duration of use time;
the pilot inputting fuel costs borne by the pilot during use of the selected resource via an expenses menu of the mobile device application as a first expense;
the pilot inputting repair costs borne by the pilot during use of the selected resource via the expenses menu of the mobile device application as a second expense;
the mobile device application executing an algorithm based on the values of the first expense, the second expense, the duration of use time, and the selected resource used to determine an incurred cost;
the mobile device application saving the incurred cost to the secured server database with the duration of use time, the current time, and the current date as attributes of the incurred cost;
the mobile device application billing the pilot the full amount of the incurred cost;
the mobile device application providing the pilot an option to pay the incurred cost via a payment menu of the mobile device application;
the pilot opting to pay the incurred cost via the payment menu; and
the mobile device application interfacing with a bank account of the pilot to pay the incurred cost.

6. The system of claim 5, further comprising:
an administrator installing the mobile device application to a mobile device of the administrator;
the administrator launching the mobile device application;
the administrator logging into the interface of the mobile device application;
the mobile device application connecting to the secured server database;
the mobile device application verifying the credentials of the administrator;
the mobile device application displaying an administrator menu to the administrator;
wherein the administrator menu contains a scheduler menu button, a resource management menu button, a user management menu button, a billing menu button, and an analysis menu button;
the administrator navigating to the resource management menu via the resource management menu button;
the mobile device application providing the administrator the option to view resource inventory, set a usage hour limit for any resource shown in inventory, flag any resource for a scheduled repair, and set the status of any resource;
wherein statuses of any resource may be set as ‘idle,’ ‘awaiting maintenance,’ ‘undergoing maintenance,’ and ‘unavailable,’ and the mobile device application updating the status of a given resource in the secured server database, removing the given resource from the list of available resources upon the administrator setting the status of a resource to one of the following: ‘awaiting maintenance,’ ‘undergoing maintenance,’ or ‘unavailable.’

7. The system of claim 6, further comprising:
the administrator navigating to the billing menu via the billing menu button of the mobile device application;
the mobile device application providing the administrator the option to view fuel and repair reimbursement requests;
the administrator viewing fuel and repair reimbursement requests;
the administrator approving the fuel and repair reimbursement requests;
the mobile device application providing the administrator the option to provide payment to Certified Flight Instructors that have accompanied the conduction of previous flights;
the administrator paying Certified Flight Instructors based on incurred cost value of the secured server database from a linked banking account of the administrator;
the mobile device application providing the administrator the option to view billing for pilot charges;
the administrator opting to view billing for pilot charges; and
the mobile device application displaying any incoming funds to the administrator.

8. The system of claim 6, further comprising:
the administrator navigating to the analysis menu via the analysis menu button of the mobile device application;
the mobile device application providing the following options to the administrator: view an overview of reports indicated by flight students, pilots, and Certified Flight Instructors, create new reports, and view visual representations of available flight data;
wherein reports include data pertaining to risk assessment, profit/loss, resource usage, and certified flight instructors;
wherein the visual representations of available flight data includes pie charts, bar charts, scatter diagrams, and histograms; and
the mobile device application providing the administrator the option to transmit reports via email.

9. The system of claim 6, further comprising:
the administrator navigating to the user management menu via the user management menu button;
the mobile device application displaying a permissions menu;
the administrator setting permission for the use of available resources for individual users based on their status as a ‘pilot;’
the administrator setting permission for the use of available resources for individual users based on their status as a ‘flight student;’
the administrator setting permission for the use of available resources for individual users based on their status as a ‘Certified Flight Instructor;’ and
wherein permissions include: resource restrictions, visibility permissions, usage time permission, and automatic approval of reservation request permission.

10. The system of claim 6, further comprising:
The administrator navigating to a scheduler menu via the scheduler menu button of the mobile device application;
the mobile device application displaying a ‘manage reservations and lessons’ screen to the administrator;
the ‘manage reservations and lessons’ screen providing the administrator the option to edit the status of pending reservations for resource use;
wherein the status may be edited to one of the following statuses: ‘approved,’ cancelled,' or ‘modified;’
the mobile device application authorizing a flight student for use of a selected resource upon receiving the status of ‘approved;’
the mobile device application locking-out a flight student from a resource upon receiving the status of ‘cancelled;’
the mobile device application authorizing a pilot for use of a selected resource upon receiving the status of ‘approved;’ and
the mobile device application locking-out a pilot from a resource upon receiving the status of ‘cancelled;’

11. The system of claim 5, further comprising:
a Certified Flight Instructor installing the mobile device application to a mobile device of the Certified Flight Instructor;
the Certified Flight Instructor launching the mobile device application;
the Certified Flight Instructor logging into the interface of the mobile device application;
the mobile device application connecting to the secured server database;
the mobile device application verifying the credentials of the Certified Flight Instructor;
the mobile device application displaying an Certified Flight Instructor menu to the Certified Flight Instructor;
wherein the Certified Flight Instructor menu contains a reservations menu button, a check-in menu button, and a logbook menu button;
the Certified Flight Instructor navigating to the reservations menu via the reservations menu button;
the mobile device application providing the Certified Flight Instruction the option to reserve a resource for use;
the Certified Flight Instructor selecting to reserve a resource for a solo flight;
the mobile device application prompting the Certified Flight Instructor to select an available date and time at which to use the resource;
the Certified Flight Instructor selecting a time, a date, and a resource;
the Certified Flight Instructor indicating a departure airport to the mobile device application;
the Certified Flight Instructor indicating an arrival airport to the mobile device application;
the mobile device application displaying the selected time, date, resource, departure airport and arrival airport to the Certified Flight Instructor for confirmation; and
the Certified Flight Instructor confirming the selected time, date, resource, departure airport, and arrival airport via the mobile device application.

13. The system of claim 12, further comprising:
the Certified Flight Instructor opting to schedule a flight lesson for a flight student to fulfill a lesson request for the flight student;
the mobile device application displaying a list of requested lessons by flight students;
the Certified Flight Instructor selecting one requested lesson from the list of requested lessons by flight students;
the Certified Flight Instructor confirming the date and time of the requested lesson;
the Certified Flight Instructor confirming the selected resource for use during the requested lesson;
the Certified Flight Instructor accepting the requested lesson as an accepted lesson;
the Certified Flight Instructor arriving at the resource at the confirmed date and time of the accepted lesson;
the Certified Flight Instructor navigating to check-in menu via the check-in menu button;
the Certified Flight Instructor navigating to a Hobbs/Tach menu from the check-in menu;
the mobile device application launching an on-board camera of the mobile device of the pilot;
the Certified Flight Instructor capturing a first picture of the Hobbs meter and tachometer on-board the resource with the camera of the mobile device;
the mobile device application employing image recognition for the numerals shown within the first picture;
the mobile device application producing a first converted text reading of the Hobbs meter and tachometer;
the mobile device application saving the first converted text reading as a Certified Flight Instructor pre-flight reading;
the mobile device application recording the geographic location of the Certified Flight Instructor and selected resource prior to flight;
the flight student conducts the flight with the Certified Flight Instructor;
the mobile device application providing the Certified Flight Instructor the option to record issues with the selected resource during use of the selected resource via text input;
the flight student landing the selected resource with the Certified Flight Instructor;
the Certified Flight Instructor navigating to the Hobbs/Tach menu;
the mobile device application launching the on-board camera of the mobile device;
the Certified Flight Instructor capturing a second picture of the Hobbs meter and tachometer of the selected resource;
the mobile device application employing image recognition for the numerals shown within the second picture;
the mobile device application producing a second converted text reading of the Hobbs meter and tachometer;
the mobile device application saving the second converted text reading as a Certified Flight Instructor post-flight reading;
the mobile device application recording the geographic location of the pilot and selected resource after the flight;
the mobile device application comparing the Certified Flight Instructor pre-flight reading and Certified Flight Instructor post-flight reading to determine a duration of use time of the Certified Flight Instructor; and
the mobile device application comparing the duration of use time of the Certified Flight Instructor to the duration of use time of the flight student for authentication.

14. The system of claim 5, wherein the pilot is a Certified Flight Instructor.
